(19) United States
(12) Patent Application Publication
(10) Pub. No.: US 2024/0038409 A1
(43) Pub. Date: Feb. 1, 2024

(54) CONNECTION DEVICE FOR PLANT FOR PROCESSING PRODUCTS BY HIGH-TEMPERATURE HEAT TREATMENT

(71) Applicant: COMMISSARIAT À L'ÉNERGIE ATOMIQUE ET AUX ÉNERGIES ALTERNATIVES, Paris (FR)

(72) Inventors: Hubert-Alexandre Turc, Les Angles (FR); Jean-François Hollebecque, Villeneuve-Les-Avignon (FR); Stéphane Lemonnier, Villeneuve-Les-Avignon (FR)

(21) Appl. No.: 18/256,180

(22) PCT Filed: Dec. 3, 2021
(86) PCT No.: PCT/FR2021/052202

§ 371 Date: Jun. 6, 2023

(30) Foreign Application Priority Data
Dec. 8, 2020 (FR) 2012828

(51) Int. Cl. G21F 9/30

(52) U.S. Cl. CPC G21F 9/305

(57) ABSTRACT

A connection device is intended for connecting a container for processing waste by high-temperature heat treatment and/or by vitrification with at least one source of products containing the waste and intended to be processed in the container and with a gas-extraction device, the connection device including a cylindrical body including a bottom end intended to be connected to the container, a top end intended to be connected to the at least one source of products and an intermediate opening intended to be connected to the gas-extraction device. The connection device includes a connection element having an element permeable to gases, which extends coaxially with the cylindrical body. The connection element includes a top end located at the top end of the cylindrical body and a bottom section that extends vertically below the bottom end of the cylindrical body.

### TECHNICAL FIELD

The invention relates to a connection device for a plant for processing products to be treated, such as waste, reagents or any other inputs by high-temperature heat treatment and/or by vitrification, as well as a processing plant including this connection device.

The invention more particularly relates to a connection device intended to allow effective separation between a flow of product to be processed and a flow of gases generated during the processing process.

The present invention lies in the field of treating mixed and hazardous waste for the purpose of processing it and storing it for long periods in suitable containers.

### PRIOR ART

In the context of the operation and/or and dismantling of nuclear installations, or other plant containing toxic or contaminated elements, it proves essential to process the waste that results therefrom, whether it consists of metal waste, for example stainless steel, copper and/or aluminium, and/or organic waste, such as for example polyvinyl chloride (PVC) and polyethylene terephthalate (PET), or even mineral waste, such as glass fibre. All these materials may be contaminated by radioactive elements, and in particular fissile materials.

Generally, this waste must be treated and processed to minimise the volume thereof in a form that allows keeping and storage thereof for long periods, according to the radioactivity thereof.

One example of a method for processing this contaminated waste consists of high-temperature vitrification with lost container. Such a method is commonly referred to as “In-Can Vitrification” or ICV.

The products may also be processed by high-temperature heat treatment. In this case, there is no vitrification but the waste is mixed with other inputs that do not necessarily react with the waste to constitute a package of processed waste at the end of the process.

Thus, and in general, the products to be processed consist of waste, reagents in the case of a vitrification operation, and inputs, which react or not with the waste but which participate in the treatment of the waste.

FIG. 1 shows an example of an embodiment of a plant 10 implementing such methods.

The plant 10 includes a container 12 in which the products to be treated are intended to be processed.

When the method is implemented, the container 12 is placed in a furnace 14 and is gradually supplied with waste to be processed.

At the end of the method, the filled container 12 is cooled and then extracted to form a package of waste, vitrified or not.

The container 12 is supplied with products to be processed by means of a connection device 16 that is connected to sources 18 of products to be processed, to an extraction device 20, which makes it possible to extract the gases produced during the processing process, and to the container 12. This connection device 16 is furthermore disposed through a wall of the furnace 14.

When the process is implemented, the products introduced are initially at ambient temperature, while the container 12 is at very high temperature. The products are then greatly heated, which produces a release of steam and gases resulting from chemical reactions in the container.

This release may also be associated with the melting of the material in the container 12.

In the connection device 16, the products have a descending vertical movement, while the gases and the steam have an ascending movement.

These two flows oppose each other and impair the efficacy of filling of the container 12.

In addition, the ascending flow of gases may take up some of the products, which are then directed towards the extraction device 20 rather than towards the container 12.

In addition, when they are introduced, the products undergo chemical and physical transformations in the connection device 16. These products may then adhere to the walls of the connection device 16 and gradually clog it. In addition, the products that agglomerate on the walls of the connection device may prevent subsequent use thereof.

The aim of the invention is to propose a connection device that makes introducing the products in the processing method more reliable.

### DESCRIPTION OF THE INVENTION

The invention proposes a connection device intended for connecting a container for processing waste by high-temperature heat treatment and/or by vitrification with at least one source of products intended to be processed in the container and with a gas-extraction device,
the connection device including a cylindrical body including a bottom end intended to be connected to the container, a top and intended to be connected to said at least one source of products and an intermediate opening intended to be connected to the gas-extraction device, characterised in that the connection device includes a connection element consisting of an element permeable to gases, which extends coaxially with the cylindrical body, wherein the connection element includes a top end located at the top end of the cylindrical body and the connection element includes a bottom section that extends vertically below the bottom end of the cylindrical body.

The connection element of the connection device delimits a conduit that makes it possible to separate the flows of waste and of gas, which therefore do not interfere with each other.

In addition, the waste does not come into contact with the walls of the connection device, preventing clogging thereof.

Preferably, the diameter of the connection element is less than the inside diameter of the cylindrical body.

Preferably, the connection element is mounted so as to be able to rotate about a common principal axis A of the cylindrical body and connection element.

Preferably, the top end of the connection element is connected to means for rotationally guiding the connection element with respect to the cylindrical body and with respect to means for rotating the connection element.

Preferably, the connection element is produced from a flexible material and the cylindrical body includes at least one obstacle that projects radially inwards with respect to an internal wall of the cylindrical body and that causes a deformation of the connection element when it is rotated in the cylindrical body.

Preferably, the bottom section includes at least one mass attached thereto.

Preferably, the mass is produced from the same material as the connection element.

Preferably, the mass is in the form of a ring coaxial with the connection element.

Preferably, the bottom section includes a plurality of masses distributed vertically.

Preferably, the connection element is an element impermeable to the waste and is permeable to the gases to be extracted by the extraction device.

Preferably, the connection element is produced from a glass-fibre fabric.

Preferably, the top end of the connection element is detachably connected to the cylindrical body.

The invention also relates to a plant for processing waste by high-temperature heat treatment including a container placed in a high-temperature furnace, at least one source of waste to be processed, a device for extracting gases generated during the operation of the plant, and a connection device according to the invention that includes a connection element, characterised in that the bottom section of the connection element extends inside the container.

Preferably, all the products to be processed in the container form a material, and the bottom section of the connection element extends inside the container as far as the surface of the material.

### BRIEF DESCRIPTION OF THE DRAWINGS

FIG. 1 is a schematic representation of a plant for processing contaminated waste, including a connection device according to the invention.

FIG. 2 is a schematic representation to a larger scale of a part of the plant shown in FIG. 1, showing the connection between the connection device, the container and the furnace.

FIG. 3 is a view to a larger scale of the connection device according to the invention.

### DETAILED DESCRIPTION OF THE INVENTION

In the description that will follow, it will be understood that the reference to the vertical orientation is in relation to terrestrial gravity.

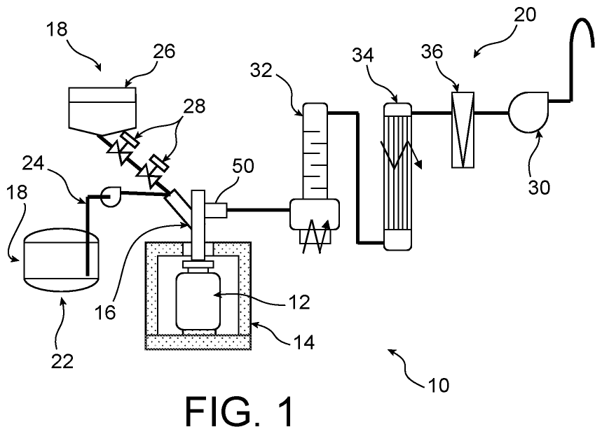

As stated previously, FIG. 1 shows a plant 10 implementing the method for processing contaminated products by high-temperature vitrification.

This plant includes a container 12, a furnace 14, a connection device 16 connecting the container 12 to sources 18 of products to be processed and to an extraction device 20.

As stated previously, the products used in the plant 10 consist of waste to be treated strictly speaking, reagents that react with the waste in the case of a vitrification operation, and inputs, which do not necessarily react with the waste but which participate in the treatment of the waste.

The products may be in liquid form, and in this case the products are stored in a tank 22 and are brought to the container 12 via the connection device 16 by a pump 24.

The products may also be in solid, powdery or viscous form, and thus be stored in a vessel 26. The products are then brought to the container 12 via the connection device 16 by gravity.

An airlock system including two valves 28 makes it possible to isolate the interior of the vessel 26, which is in contact with the ambient air, from the rest of the interior of the plant 10 where gases to be treated are present.

The airlock system makes it possible to gradually introduce the products into the plant without risking discharges of gas to the outside, or risking air being introduced into the plant.

The extraction device 20 includes an extractor 30 that sucks the gases produced during the implementation of the processing method and discharges them in the direction of suitable retreatment and/or storage means. It will be understood that other components for treating the gases may be disposed in the extraction device 20, upstream or downstream of the extractor, without departing from the technical field of the invention.

The extraction device 20 also includes a deduster 32, a washer/condenser 34 and a very high density filter 36, all disposed upstream of the extractor 30.

The deduster 32 settles the dust present in the flow of gases taken off by counter-flow circulation of a liquid raised to boiling point.

The washer/condenser 34 implements a cooling of the gases coming from the deduster 32 and an additional washing by counter-flow circulation of an acidulated or complexing solution.

The filter 36 provides a last barrier to fine products and particles, before reaching the extractor 30.

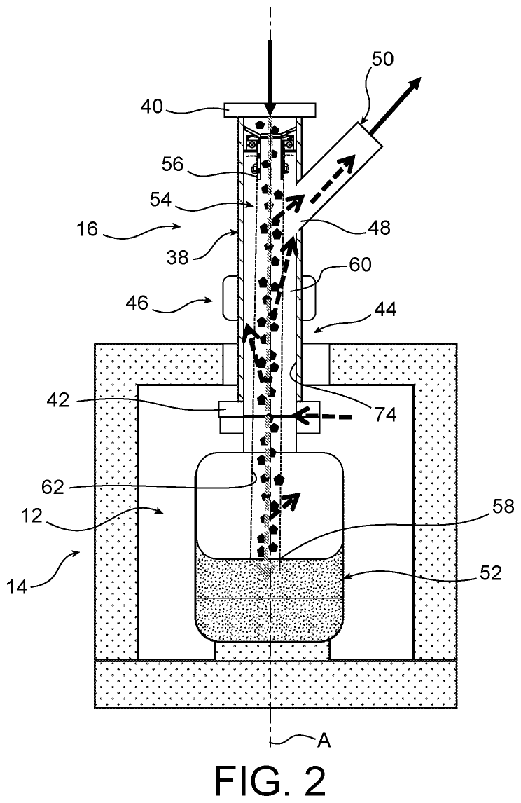

As can be seen in more detail in FIG. 2, the connection device 16, which connects the container 12 to the sources 18 of products and to the extraction device 20, includes a cylindrical body 38 including a principal axis A oriented vertically in the direction of terrestrial gravity.

This cylindrical body 38 includes a top end 40 that is connected to the sources 18 of products and a bottom end 42 that is connected to the container 12.

The bottom end 42 is thus located inside the furnace 14, which includes an opening 44 through which the cylindrical body 38 passes.

In addition, the bottom end 42 of the cylindrical body 38 being in contact with the container 12 and in the furnace 14, it is raised to a high temperature, substantially equal to that of the container 12.

To limit the heating of the top part of the connection device 16, the cylindrical body 38 includes a double jacket 46 located outside the furnace 14, the purpose of which is to limit the propagation of heat upwards.

By way of non-limitative example, the double jacket 46 includes a conduit (not shown) for circulation of a heat-transfer fluid such as for example refrigerated or heat-regulated water or pressurised air.

The cylindrical body 38 includes, in the top part thereof, an opening 48 and an external sleeve 50 connecting the interior volume of the connection device to the extraction device 20.

When the product-processing method is implemented, the products flow vertically downwards through the cylindrical body, under the action of terrestrial gravity.

On entering the container 12, at least some of the products melt. The material 52 gradually accumulates inside the container 12, until it fills it. In the following description, the term material 52 will be used to designate all the products present inside the container 12 and which are raised to high temperature for treatment thereof, whether or not these products have melted.

When they are raised to high-temperature and/or when they come into contact with the molten material, the products produce gases that flow vertically upwards through the cylindrical body 38, i.e. in the opposite direction with respect to the products supplying the container 12.

To separate the flow of gas from the flow of products, the connection device 16 includes a connection element 54 disposed in the cylindrical body 38.

This connection element 54 delimits a conduit extending in the cylindrical body 38 from the top end 40 of the cylindrical body 38 as far as the interior of the container 12.

According to a preferential but non-limitative embodiment, the connection element 54 consists of a tubular element that extends coaxially with the cylindrical body 38, i.e. in the vertical direction.

It includes a top end 56 that is located at the top end 40 of the cylindrical body 38 and a bottom end 58 that is in contact with the material 52.

Thus, the connection element 54 includes a top section 60 disposed in the cylindrical body 38 of the connection device 16 and a bottom section 62 that extends vertically below the bottom end 42 of the cylindrical body 38.

The free end of the bottom section 62 being in contact with the material 52, it is caused to mix therewith as the level of material 52 in the container 12 rises.

Preferably, the connection element 54 is produced from a material that can be preserved in the material to be processed. The connection element 54 is then “lost”. According to a variant, only the bottom section 62 of the connection element 54 is lost and is therefore detached from the rest of the connection element 54.

The physical and chemical reactions generating gases occur both inside the connection element 54 and outside it.

Thus, to allow the discharge of the gases and flow thereof in the direction of the extraction device 20, the connection element 54 is designed to be permeable to the gases and impermeable to the products that are poured into the container 12.

The dimensions of the connection element 54 are less than the inside diameter of the cylindrical body 38.

Thus the connection element 54 extends radially at a distance from an internal wall 74 of the cylindrical body 38, thus delimiting a peripheral conduit in which the gases intended to be extracted can flow.

According to a preferred embodiment, the connection element 54 is produced from a glass-fibre fabric, which can thus be melted with the rest of the molten material, but not melt at ambient temperature in the furnace and in the container. Preferably, this material is based on silica.

The dimensional characteristics of the connection element 54 are defined to allow the conveying of the products from the top end 40 of the cylindrical body 38 as far as the bath of material 52.

The size of the meshes of the fabric must form a barrier to all the types of products conveyed through the connection element 54 and allow the escape of the gases to the extraction device 20.

According to a variant embodiment, the connection element 54 consists of a metal tube, for example made from stainless steel or aluminium, which includes orifices intended for the escape of the gases to the extraction device 20.

According to a non-limitative example embodiment, the connection element 54 measures 2.5 metres in length and has a diameter of 20 centimetres.

When the products flow through the connection element 54, it may happen that they cluster in it, and clog it.

To prevent this clogging, and therefore favour the flow of the products in the connection element 54, the connection element 54 is a flexible element and the connection device 16 includes means for periodic deformation of the connection element 54. This embodiment is advantageous when the connection element 54 is produced from a glass-fibre fabric, as described previously.

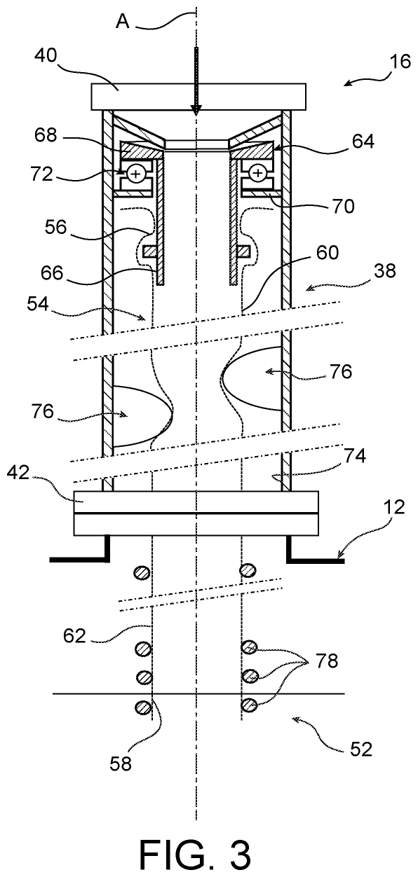

According to another aspect of the connection device shown in FIG. 3, the connection device 54 is mounted so as to be able to rotate in the cylindrical body 38 about the principal axis A.

For this, the top end 56 of the connection element 54 is connected to a rotating support 64 that is rotationally supported by the cylindrical body 38. This rotating support 64 is able to have the products to be processed pass through it.

The rotating support 64 includes a cylindrical barrel 66 on which the top end 56 of the connection element 54 is secured and a top radial collar 68 that provides the rotational connection of the rotating support with the cylindrical body 38.

The cylindrical body 38 includes an annular base 70 extending in a plane perpendicular to the principal axis A, which supports the rotating support 64, in particular by means of its radial collar 68 by means here of a ball bearing 72.

The rotating support 64 is furthermore connected to means for driving in rotation (not shown).

In addition to its rotation about the vertical principal axis A, the connection element 54 also undergoes deformations radially to prevent the clogging of the connection element 54.

The internal wall 74 of the cylindrical body includes for this purpose obstacles 76, here produced from a metal similar to that of the cylindrical body 38, which project radially in the direction of the connection element 54.

The radial height of each obstacle 76 is greater than the radial distance between the connection element 54 and the internal wall 74 of the cylindrical body 38 to produce the radial deformation of the connection element 54.

The obstacles 76 are distributed over the internal wall 74 of the cylindrical body 38 vertically and circumferentially, in order not to impair the possibility of flow of the products.

The bottom end 58 of the connection element 54 is in permanent contact with the material 52, which may prevent the connection element 54 from keeping its cylindrical shape during rotation.

For this purpose, masses 78 are disposed on the bottom section 62 of the connection element 54. These masses 78 are preferably annular and mounted outside the connection element 54, in order not to interfere with the flow of the products.

The masses 78 are preferably produced from the same material as the connection element 54, in order to be melted in the final processing material and optionally in the material 52. It will be understood that variant embodiments according to which all the masses 78 or some of them are produced from materials other than the material of the connection element 54 can also form part of the invention.

The presence of a part of the bottom section 62 of the connection element 54, and optionally of masses 78 in the molten material, combined with the rotation movement of the connection element 54, makes it possible to produce a stirring of the material 52. This function is used for improving the homogenisation conditions, which is also important for the methods that use heat convection in the molten medium to provide this mixing.

According to another aspect of the connection element 54, whether this is able to rotate, or not, about the principal axis A, its top end 56 is connected detachably to the top end 40 of the cylindrical body 38.

This makes it possible, at the end of the filling sequence of the processing method, to detach the connection element 54 and allow it to fall into the container 12. The connection element 54 can then be incorporated in the material 52 and be melted, or not.

A method for processing products using the plant 10 that has just been described thus includes the successive steps:

Firstly, a container 12, optionally loaded with products, is placed in the furnace 14 and is then connected to the connection device 16.

Next, a connection element 54 is fitted in the connection device 16 from the top end 40 of the cylindrical body 38.

Next, the furnace 14 is heated, the extraction device is started up and the connection element 54 is set in rotation where applicable.

The container 12 is next supplied with products to be processed by means of the connection device 16.

The products then heat up and degas, and the gases produced are discharged through the connection element 54 to the extraction device 20. On arriving at the surface of the material 52, the products supplied and heated are incorporated in this accumulation of material 52.

As the container 12 fills, the connection element 54 and, where applicable, the masses 78 that come into contact with the material.

When all the products to be processed have been incorporated in the container 12, the rotation of the connection element 54 is stopped and then the connection element 54 is detached from the top end 40 of the cylindrical body 38 in order to be incorporated in the material 52.

The connection element 54, on which products may remain stuck, is not used for the following implementation of the processing method, but renewed, which makes it possible to ensure repeatability of the method, without variations in implementation conditions.

In a method for processing materials resulting from the clean-up/dismantling of nuclear installations at the end of operation, the characteristics of which would be neither perfectly known nor homogeneous over the whole of the body to be treated, the use of a connection element 54 that extends from the top end 40 of the cylindrical body 38 as far as the material 52 makes it possible to maintain the state of cleanliness of the process equipment; the latter is not contaminated, or much less so, by powdery materials and radiocontaminants present in particulate form. Renewal of the connection element 54 furthermore makes it possible to ensure radiological cleanliness of the plant 10.

What is claimed is:

1. Connection device intended for connecting a container for processing waste by high-temperature heat treatment and/or by vitrification with at least one source of products containing said waste and intended to be processed in the container and with a gas-extraction device,
the connection device including a cylindrical body including a bottom end intended to be connected to the container, a top end intended to be connected to said at least one source of products and an intermediate opening intended to be connected to the gas-extraction device,
wherein
the connection device includes a connection element consisting of an element permeable to gases, which extends coaxially with the cylindrical body, wherein the connection element includes a top end located at the top end of the cylindrical body and the connection element includes a bottom section that extends vertically below the bottom end of the cylindrical body.

2. Connection device according to claim 1, wherein the diameter of the connection element is less than the inside diameter of the cylindrical body.

3. Connection device according to claim 1, wherein the connection element is mounted so as to be able to rotate about a common principal axis-(A) of the cylindrical body and connection element.

4. Connection device according to claim 3, wherein the top end of the connection element is connected to means for rotationally guiding the connection element with respect to the cylindrical body and with respect to means for rotating the connection element.

5. Connection device according to claim 3, wherein the connection element is produced from a flexible material and the cylindrical body includes at least one obstacle that projects radially inwards with respect to an internal wall of the cylindrical body and that causes a deformation of the connection element when it is rotated in the cylindrical body.

6. Connection device according to claim 1, wherein the bottom section includes at least one mass attached thereto.

7. Connection device according to claim 6, wherein the mass is produced from the same material as the connection element.

8. Connection device according to the claim 7, wherein the mass is in the form of a ring coaxial with the connection element.

9. Connection device according to claim 6, wherein the bottom section includes a plurality of masses distributed vertically.

10. Connection device according to claim 1, wherein the connection element is an element impermeable to the waste and is permeable to the gases to be extracted by the extraction device.

11. Connection device according to claim 10, wherein the connection element is produced from a glass-fibre fabric.

12. Connection device according to claim 1, wherein the top end of the connection element is connected detachably to the cylindrical body.

13. Plant for processing waste by high-temperature heat treatment including
a container placed in a high-temperature furnace,
at least one source of waste to be processed,
a device for extracting gases generated during the operation of the plant,
a connection device according to claim 1, which includes a connection element,
wherein the bottom section of the connection element extends inside the container.

14. Plant according to claim 13, wherein all the products to be processed in the container form a material, wherein the bottom section of the connection element extends inside the container as far as the surface of the material.
